(19) United States
(12) Patent Application Publication
(10) Pub. No.: US 2018/0218757 A1
(43) Pub. Date: Aug. 2, 2018

(54) SYSTEM AND A METHOD FOR GENERATING PERSONALIZED PLAYLIST OF HIGHLIGHTS OF RECORDED MULTIMEDIA CONTENT

(71) Applicant: Wipro Limited, Bangalore (IN)

(72) Inventor: Gowrishankar Subramaniam NATARAJAN, Chennai (IN)

(73) Assignee: Wipro Limited

(21) Appl. No.: 15/461,060

(22) Filed: Mar. 16, 2017

(30) Foreign Application Priority Data
Jan. 27, 2017 (IN) 201741003007

(51) Int. Cl. G11B 27/034; G11B 27/10; H04N 5/91; H04N 5/76; G11B 27/00; G06F 17/30

(52) U.S. Cl. CPC G11B 27/034; G11B 27/105; H04N 5/91; G06F 17/30053; G11B 27/005; G06F 17/30029; H04N 5/7605

(57) ABSTRACT

Disclosed herein is a system and method for generating personalized playlist of highlights of plurality of recorded multimedia content. One or more recorded multimedia content is selected based on relative scores assigned to each of the plurality of recorded multimedia content based on predetermined configurable rules and profile information of the user. Highlights of each of the selected multimedia content are created based on predetermined configurable rules. Finally, each highlight is ordered based on the user profile for generating a personalized playlist of the highlights. The disclosed method automatically generates a highlight of the selected plurality of recorded multimedia content, thereby assisting the users in viewing the appropriate multimedia content as per their interests and convenience.

### TECHNICAL FIELD

The present subject matter is related, in general to multimedia content management, and more particularly, but not exclusively to a system and a method for generating a personalized playlist of highlights of plurality of recorded multimedia content.

### BACKGROUND

Currently, time shift viewing of videos, television series or any multimedia content plays a dominant role in the field of video entertainment. The viewers would like to watch these multimedia content as per their convenience and interests, on a device that they want to watch them on. Hence, various time shifting and/or content recording techniques have been developed and put in practice to serve the viewers as per the convenience and interest of the viewers.

The time shifting techniques have become increasingly popular over the years and provide various time and place shift viewing features for the viewers. Also, since the storage devices, both the local and the remote storage devices, have become cheaper, the viewers have leveraged their near storage space to record and store multiple multimedia content. Some of the multimedia content recording techniques include recording on an embedded hard-disk within a media gateway or within a Set Top Box (STB) connected to the television, recording on an USB attached to the hard-disk or STB and recording the content onto a cloud storage associated with the viewers.

However, accessing a specific recording of multimedia content, which reflects the viewer's preferences, mood and taste at any point in time can be cumbersome and time consuming. Further, it is difficult for a viewer to preview sample of an entire collection of the recorded multimedia content before selecting required multimedia content for viewing. Hence, the viewers cannot make a quick decision on which recorded multimedia content to view, in an easy and intuitive manner.

### SUMMARY

Disclosed herein is a method for generating a personalized playlist of highlights of plurality of recorded multimedia content. The method comprises assigning, by a personalized playlist generator, a relative score to each of the plurality of recorded multimedia content based on one or more parameters associated with a user profile. Further, one or more recorded multimedia content is selected from the plurality of recorded multimedia content based on the relative score of each of the plurality of recorded multimedia content. Upon selecting the one or more recorded multimedia content, a highlight of each of the selected one or more recorded multimedia content is created based on predetermined configurable rules. Finally, the highlight of each of the selected one or more recorded multimedia content is ordered based on the user profile for generating a personalized playlist of the highlight of each of the selected one or more recorded multimedia content.

Further, the present disclosure discloses a personalized playlist generator for generating personalized playlist of highlights of plurality of recorded multimedia content. The personalized playlist generator comprises a processor and a memory. The memory is communicatively coupled to the processor, wherein the memory stores processor-executable instructions, which, on execution, causes the processor to assign a relative score to each of the plurality of recorded multimedia content based on one or more parameters associated with a user profile. Further, the processor selects one or more recorded multimedia content from the plurality of recorded multimedia content based on the relative score of each of the plurality of recorded multimedia content. Upon selecting the one or more recorded multimedia content, the processor creates highlight of each of the selected one or more recorded multimedia content based on predetermined configurable rules. Finally, the processor orders the highlight of each of the selected one or more recorded multimedia content based on the user profile for generating a personalized playlist of the highlight of each of the selected one or more recorded multimedia content.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The accompanying drawings, which are incorporated in and constitute a part of this disclosure, illustrate exemplary embodiments and, together with the description, explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 shows an exemplary environment for generating personalized playlist of highlights of plurality of recorded multimedia content in accordance with some embodiments of the present disclosure;

FIG. 2 shows a detailed block diagram illustrating a personalized playlist generator for generating personalized playlist of highlights of plurality of recorded multimedia content in accordance with some embodiments of the present disclosure;

FIG. 3 shows an exemplary illustration of generating personalized playlist of highlights of recorded multimedia content in accordance with few embodiments of the present disclosure;

FIG. 4 shows a flowchart illustrating a method for generating personalized playlist of highlights of recorded multimedia content in accordance with some embodiments of the present disclosure; and

FIG. 5 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The present disclosure relates to a method and a personalized playlist generator for generating playlist of highlights of plurality of recorded multimedia content. The highlight of a selected one of the plurality of recorded multimedia content comprises a part and/or a combination of multiple parts of the recorded multimedia content corresponding to the selected one of the one or more recorded multimedia content. As an example, the highlight of a recorded multimedia content ‘M’, which has a total playback time of 30 minutes, may be created by segmenting the multimedia content ‘M’ into 30 segments, each having a playback time of 1 minute, and then combining only selected segments, say 3 segments out of the 30 segments, based on the predetermined configurable rules. As an example, the predetermined configurable rules that are considered for creating the highlight may include, without limiting to, genre of the selected multimedia content, a standard template for creating the highlight, frequency of access of the selected multimedia content, pause points in the selected multimedia content, user preference and bookmarks within the selected multimedia content.

In some embodiments, the personalized playlist generator identifies and prioritizes one or more recorded multimedia content of the plurality of recorded multimedia content, from which the highlights may be generated based on the interests and other profile information stored in a viewership profile and/or user profile of the user. Further, the present disclosure discloses a method for generating a playlist of the highlights of the selected one or more recorded multimedia content. In some embodiments, the highlight of each of the selected one or more multimedia content corresponds to one of the selected one or more recorded multimedia content and provides a simple preview of the recorded multimedia content.

In some embodiments, the present disclosure also discloses personalization of the playlist of highlights based on the information in the user profile. As an example, the user profile may comprise information related to viewing preference of the user, viewing pattern of the user, content bookmarks created by the user, favorite multimedia genre of the user, last viewed recorded multimedia content by the user, duration of the last viewed recorded multimedia content and information related to one or more electronic devices used by the user for viewing the multimedia content. Further, the highlights are ordered and provided to the user based on the information in the user profile.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

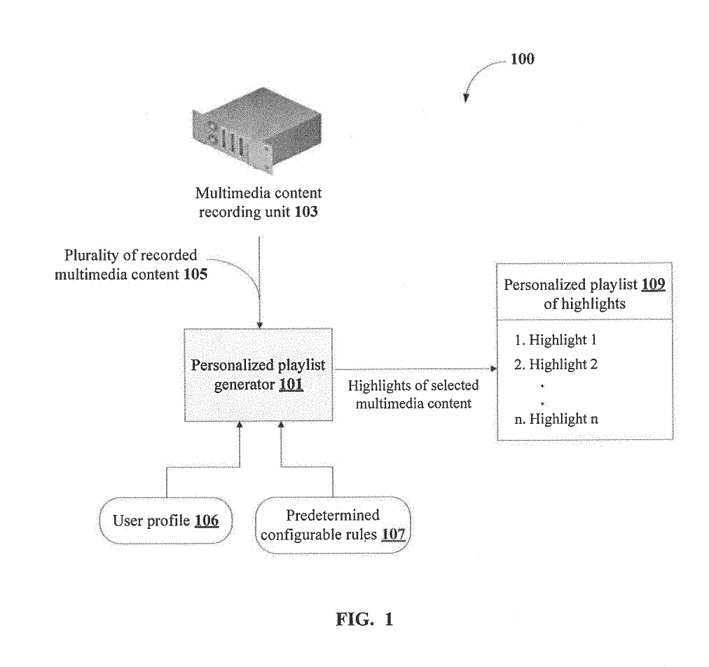

FIG. 1 shows an exemplary environment for generating personalized playlist of highlights of plurality of recorded multimedia content in accordance with some embodiments of the present disclosure.

Accordingly, the environment 100 comprises a personalized playlist generator 101 for generating a personalized playlist 109 of highlights of plurality of recorded multimedia content 105. In some embodiments, the plurality of recorded multimedia content 105 may be recorded and stored in a multimedia content recording unit 103 associated with the user. As an example, the multimedia content recording unit 103 may be a Set Top Box (STB) or Set Top Unit (STU) associated with a television, which may be configured to record and store the plurality of recorded multimedia content 105 being telecasted in the TV. The STB may store the plurality of recorded multimedia content 105 on a Hard Disk Drive (HDD) embedded within the STB. Alternatively, the multimedia content recording unit 103 may also store the plurality of recorded multimedia content 105 on a Universal Serial Bus (USB) storage unit or a cloud storage unit associated with the multimedia content recording unit 103.

In some embodiments, the personalized playlist generator 101 selects one or more recorded multimedia content 105A from the plurality of recorded multimedia content 105 based on one or more parameters associated with the user profile 106. As an example, the one or more parameters associated with the user profile 106 may comprise, without limiting to, viewing preference of the user, viewing pattern of the user, content bookmarks created by the user, favorite multimedia genre of the user, last viewed recorded multimedia content by the user, duration of the last viewed recorded multimedia content and information related to one or more electronic devices used by the user for viewing the multimedia content. Upon selecting the one or more recorded multimedia content 105A, the personalized playlist generator 101 creates a highlight of each of the selected one or more recorded multimedia content 105A using predetermined configurable rules 107. As an example, the predetermined configurable rules 107 may comprise, without limiting to, genre of the selected one or more recorded multimedia content 105A, a standard template for creating the highlight, frequency of access of the genre of the selected one or more recorded multimedia content 105A, pause points in the selected one or more recorded multimedia content 105A, user preference in watching the selected one or more recorded multimedia content 105A of similar genre, bookmarks on the selected one or more recorded multimedia content 105A, presence of content markers in the selected one or more recorded multimedia content 105A and presence of Increased Digital Resolution (IDR) frames within the selected one or more recorded multimedia content 105A.

In some embodiments, the personalized playlist generator 101 creates the playlist of the highlights of each of the selected one or more recorded multimedia content 105A based on the one or more parameters associated with the user profile 106. The personalized playlist 109 is a list of the highlights of the selected one or more recorded multimedia content 105A which may be provided to the user through an electronic device associated with the user.

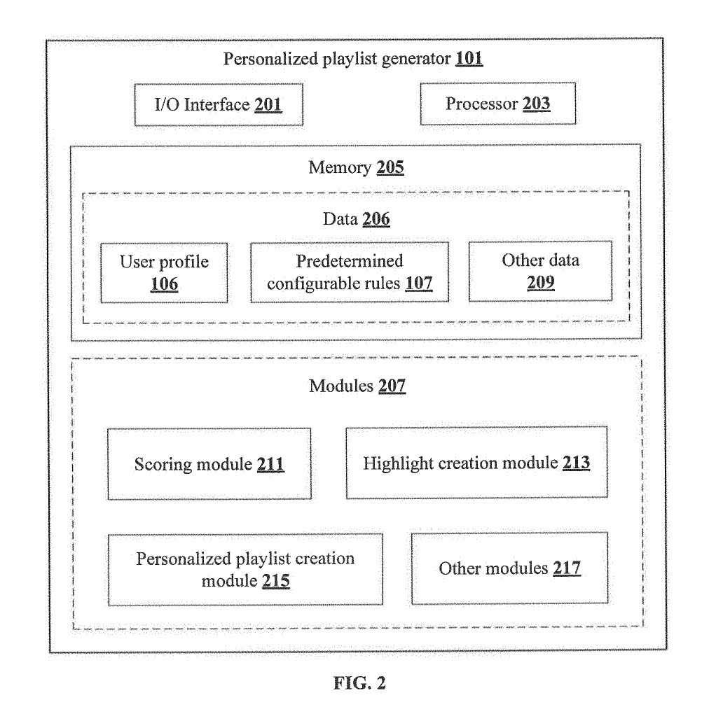

FIG. 2 shows a detailed block diagram illustrating a personalized playlist generator for generating personalized playlist of highlights of plurality of recorded multimedia content in accordance with some embodiments of the present disclosure.

The personalized playlist generator 101 comprises an I/O interface 201, a processor 203 and a memory 205. The I/O interface 201 may be configured to access the plurality of recorded multimedia content 105 which are recorded and stored in the multimedia content recording unit 103. The memory 205 may be communicatively coupled to the processor 203. The processor 203 may be configured to perform one or more functions of the personalized playlist generator 101 for generating the personalized playlist 109 of the highlights of the plurality of recorded multimedia content 105. In one implementation, the personalized playlist generator 101 comprises data 206 and modules 207 for performing various operations in accordance with the embodiments of the present disclosure. In an embodiment, the data 206 may be stored within the memory 205 and may include, without limiting to, user profile 106, predetermined configurable rules 107 and other data 209.

In one embodiment, the data 206 may be stored within the memory 205 in the form of various data structures. Additionally, the data 206 may be organized using data models, such as relational or hierarchical data models. The other data 209 may store data, including temporary data and temporary files, generated by modules 207 while generating the personalized playlist 109 of the highlights of the plurality of recorded multimedia content 105.

In some embodiment, the user profile 106 may comprise information related to the interests and convenience of the user in viewing the plurality of recorded multimedia content 105. One or more parameters associated with the user profile 106 may include, without limiting to, viewing preference of the user, viewing pattern of the user, content bookmarks created by the user, favorite multimedia genre of the user, last viewed recorded multimedia content by the user, duration of the last viewed recorded multimedia content and information related to one or more electronic devices used by the user for viewing the multimedia content. In an implementation, the user profile 106 may be stored in the multimedia content recording unit 103 and may be dynamically retrieved by the personalized playlist generator 101 while generating the personalized playlist 109 for the user.

As an example, the viewing preference of the user includes details related to language preferences of the user. The viewing pattern comprises information related to time of day in which the user views the plurality of recorded multimedia content 105. The content bookmarks are the trace points in the plurality of recorded multimedia content 105, which are reference points from which the user can resume a previous instance of playing the plurality of recorded multimedia content 105. The content bookmarks may be static or dynamic. A static bookmark is created by the user. A dynamic bookmark is automatically created when there is an abrupt end to a playing instance of the plurality of recorded multimedia content 105. The favorite multimedia genre of the user includes one or more multimedia genres which are most preferred and/or liked by the user. As an example, various multimedia genre includes, without limiting to, Fiction, Comedy, Drama, Horror, Non-fiction, Realistic fiction, Romance, Satire etc.

In some embodiments, the predetermined configurable rules 107 are used by the personalized playlist generator 101 while creating the highlights of the selected one or more recorded multimedia content 105A. The predetermined configurable rules 107 are derived from standard policies and rules that govern the telecast and viewing of various multimedia content. As an example, the predetermined configurable rules 107 may comprise, without limiting to, genre of the selected one or more recorded multimedia content 105A, a standard template for creating the highlight, frequency of access of the genre of the selected one or more recorded multimedia content 105A, pause points in the selected one or more recorded multimedia content 105A, user preference in watching the selected one or more recorded multimedia content 105A of similar genre, bookmarks on the selected one or more recorded multimedia content 105A, presence of content markers in the selected one or more recorded multimedia content 105A and presence of Increased Digital Resolution (IDR) frames within the selected one or more recorded multimedia content 105A. In an implementation, the predetermined configurable rules 107 may be stored in a rules database associated with the personalized playlist generator 101. In another implementation, the predetermined configurable rules 107 may be obtained from an external system/storage unit.

In some embodiment, the data 206 may be processed by one or more modules 207 in the personalized playlist generator 101. In one implementation, the one or more modules 207 may be stored as a part of the processor 203. In another implementation, the one or more modules 207 may be communicatively coupled to the processor 203 for performing one or more functions of the personalized playlist generator 101. The modules 207 may include, without limiting to, a scoring module 211, a highlight creation module 213, a personalized playlist creation module 215 and other modules 217.

As used herein, the term module refers to an application specific integrated circuit (ASIC), an electronic circuit, a processor (shared, dedicated, or group) and memory that execute one or more software or firmware programs, a combinational logic circuit, and/or other suitable components that provide the described functionality. In an embodiment, the other modules 217 may be used to perform various miscellaneous functionalities of the personalized playlist generator 101. It will be appreciated that such modules 207 may be represented as a single module or a combination of different modules.

The scoring module 211 may be responsible for assigning a relative score to each of the plurality of recorded multimedia content 105 based on one or more parameters associated with the user profile 106. Further, upon assigning the relative scores, the scoring module 211 selects one or more recorded multimedia content 105A from the plurality of recorded multimedia content 105 based on the relative score of each of the plurality of recorded multimedia content 105. In some embodiments, the scoring module 211 may use the predetermined configuration rules for selecting the one or more recorded multimedia content 105A for creating the highlights based on the one or more parameters associated with the user profile 106. Further, the scoring module 211 may process through the plurality of recorded multimedia content 105 to select the one or more recorded multimedia content 105A.

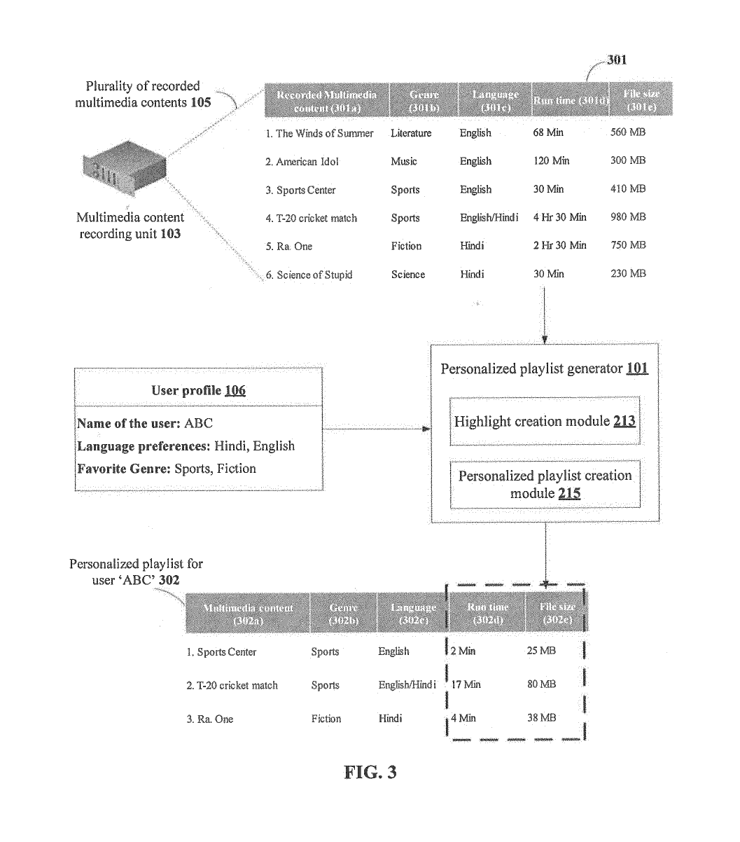

In some embodiments, the one or more recorded multimedia content 105A having a relative score greater than a predetermined configurable threshold score among the plurality of recorded multimedia content 105 is selected for creating the highlight. As an example, the predetermined configurable threshold score may be ‘7’ on a scale of 10. Which means that, each of the selected one or more recorded multimedia content 105A, having a relative score of more than ‘7’ are selected for creating the highlights. The mechanism of assigning the relative scores to the plurality of recorded multimedia content 105 and selecting the one or more recorded multimedia content 105A from the plurality of recorded multimedia content 105 based on their relative scores is explained in detail with the help of FIG. 3 in the further section of the disclosure.

The highlight creation module 213 may be responsible for creating the highlight of each of the selected one or more recorded multimedia content 105A based on the predetermined configurable rules 107. In an embodiment, the highlight creation module 213 comprises identifying one or more segments of the multimedia content in each of the selected one or more recorded multimedia content 105A. Upon identifying the one or more segments, the highlight creation module 213 assigns a relative segment score to each of the one or more segments of the multimedia content based on the one or more parameters associated with the user profile 106. As an example, the one or more segments of the multimedia content may be identified by splitting the entire multimedia content into multiple parts having equal runtime or playback time, say a playback time of 1 minute. Further, the highlight creation module 213 combines the one or more segments of the multimedia content based on the relative segment score to create the highlight of each of the selected one or more recorded multimedia content 105A.

The personalized playlist creation module 215 may be responsible for ordering the highlight of each of the selected one or more recorded multimedia content 105A based on the user profile 106, thereby generating a personalized playlist 109 of the highlight of each of the selected one or more recorded multimedia content 105A. Further, the personalized playlist creation module 215 may also be responsible for providing the personalized playlist 109 to the user through the one or more electronic devices associated with the user.

In some embodiments, each of the highlights comprised in the personalized playlist 109 of highlights may be a link, such as Universal Resource Locators (URLs), to a corresponding recorded multimedia content of the plurality of recorded multimedia content 105 in its original state, from which the highlight has been created. Further, the personalized playlist creation module 215 may dynamically update the personalized playlist 109 of the highlights based on the one or more parameters associated with the user profile 106. For example, the viewing pattern of the user may change over a certain period due to changes in the routine of the user or due to a busy schedule of the user. In such scenarios, the personalized playlist creation module 215 identifies and considers the changes in the viewing pattern of the user and accordingly updates the personalized playlist 109 of highlights to keep the personalized highlights in-line with the interests and requirements of the user.

In some embodiments, upon providing the personalized playlist 109 of highlights to the user, the user may browse through the personalized playlist 109 of highlights and may select one of the one or more highlights in the playlist for playback or viewing. Then, the personalized playlist generator 101 may provide an option to the user to either playback the selected highlight alone or to playback the entire recorded multimedia content corresponding to the selected highlight. If the user chooses to play the highlight, then the selected highlight may be streamed to the user through a highlight streaming server (not shown in figures). The highlight streaming server may be responsible for retrieving the appropriate highlight and presenting it to the user.

Further, if the user chooses to playback the entire recorded multimedia content corresponding to the highlight, then the highlight streaming server interfaces with the multimedia content recording unit 103 to fetch the requested recorded multimedia content. In some embodiments, the highlight streaming server may update the status of the viewed multimedia content as “Watched & accessed”, indicating that the recorded multimedia content has been accessed and viewed by the user. On the other hand, if only the highlight was viewed, then the status may be updated as “Watched”. Finally, the status of each of the plurality of recorded multimedia content 105 may be considered as a parameter to dynamically build a improvised user profile 106.

FIG. 3 shows an illustration of generating personalized playlist of highlights of recorded multimedia content in accordance with an exemplary embodiment of the present disclosure.

Consider a user ‘ABC’, who uses a STB for subscribing one or more television channels/services from one of a third-party digital television service provider. The STB may be capable of recording and storing the plurality of recorded multimedia content 301a being telecasted in the one or more channels/services. In an implementation, the personalized playlist generator 101 disclosed in the instant disclosure may be integrated with the STB associated with the user ‘ABC’ to generate and provide a personalized playlist 302 of the plurality of recorded multimedia content 301a, recorded by the STB, to the user ‘ABC’.

As an example, the list 301 in FIG. 3 indicates a list of the plurality of recorded multimedia content 105 that are recorded and stored in the STB associated with the user. Each of the plurality of recorded multimedia content 301a may have different multimedia content characteristics, i.e. genre 301b, language 301c, run time (playback time) 301d and file size 301e of the recorded multimedia content 301a. For example, as indicated in the list 301, one of the plurality of recorded multimedia content 301a is a literature oriented show—‘The Winds of Summer’, which is in English and has a total playback time 301d of 68 minutes, having a file size 301e of 560 MB when recorded and stored. Similarly, the plurality of recorded multimedia content 301a include various other television shows belonging to various genres 301b and language 301c of telecast, as indicated in the list 301.

The user profile 106 of the user ‘ABC’ may comprise various information related to the user ‘ABC’. As an example, the user profile 106 may include language 301c preferences of the user and favorite multimedia genre 301b of the user. In the instant example, the languages 301c preferred by the user ‘ABC’ may be ‘Hindi’ and ‘English’. Similarly, the favorite genre 301b of the user may be ‘Sports’ and ‘Fiction’, as indicated in FIG. 3.

Now, the scoring module 211 in the personalized playlist generator 101 assigns a relative score to each of the plurality of recorded multimedia content 301a in the list 301 to select one or more recorded multimedia content 302a among the plurality of recorded multimedia content 301a for creating the highlights. The relative score may be assigned based on the information stored in the user profile 106 of the user ‘ABC’. Accordingly, the one or more of recorded multimedia content 301a that closely match with the parameters in the user profile 106 may be assigned a higher relative score when compared to the other multimedia content. Table A below indicates exemplary relative scores assigned to each of the plurality of recorded multimedia content 301a based on the information in the user profile 106.

TABLE A
Relative score of the plurality of recorded multimedia content

| Recorded multimedia | Relative score (Out |
|---|---|
| content 301a | of 10) |
| 1. The Winds of Summer | 5 |
| 2. American Idol | 5 |
| 3. Sports Center | 9 |
| 4. T-20 Cricket match | 9 |
| 5. Ra. One | 8 |
| 6. Science of Stupid | 4 |

Here, the plurality of recorded multimedia content 301a, ‘Sports Center’ (belonging to ‘Sports’ genre 301b and telecasted in ‘English’) and ‘T-20 Cricket match’ (belonging to ‘Sports’ genre 301b and telecasted in either ‘English’ or ‘Hindi’) have been assigned a highest relative score of ‘9’, since the user profile 106 of ‘ABC’ indicates that the user ‘ABC’ has more interest in ‘Sports’ related multimedia content and also that the preferred languages 301c of the user ‘ABC’ are ‘English’ and ‘Hindi’. Similarly, the multimedia content 301a ‘Ra. One’ (belonging to ‘Fiction’ genre 301b and telecasted in ‘Hindi’) is assigned a relative score of 8 since the user profile 106 indicates that the user is interested in viewing ‘Fiction’ related multimedia content 301a, which is prioritized next to the ‘Sports’ related multimedia content. Further, the recorded multimedia content 301a—‘The World of Summer’ (belonging to ‘Literature’ genre 301b and telecasted in ‘English’), ‘American Idol’ (belonging to ‘Music’ genre 301b and telecasted in ‘English’) and ‘Science of Stupid’ (belonging to ‘Science’ genre 301b and telecasted in ‘Hindi’) are assigned a lower relative score since they do not belong to the favorite multimedia content genre 301b of the user ‘ABC’.

Now, upon assigning the relative scores to each of the plurality of recorded multimedia content 301a, the personalized playlist generator 101 selects the one or more recorded multimedia content 302a from the plurality of recorded multimedia content 301a for creating highlights based on their respective relative scores. As an example, the selected one or more recorded multimedia content 302a having the relative score higher than ‘7’ may be selected for creating the individual highlights. Table B indicates the one or more recorded multimedia content 302a selected for creating the highlights among the plurality of recorded multimedia content 301a indicated in Table A.

TABLE B
List of selected recorded multimedia content.

| Selected recorded | Relative score |
|---|---|
| multimedia content 302a | (Out of 10) |
| 1. Sports Center | 9 |
| 2. T-20 Cricket match | 9 |
| 3. Ra. One | 8 |

After selecting the one or more recorded multimedia content 302a from the plurality of recorded multimedia content 301a, the personalized playlist generator 101 uses the one or more predetermined configurable rules 107 (not shown in FIG. 3) for creating the highlights of each of the selected one or more recorded multimedia content 302a. Initially, the personalized playlist generator 101, using the highlight creation module 213, identifies one or more segments of the multimedia content in each of the selected one or more recorded multimedia content 302a. Later, the highlight creation module 213 assigns a relative segment score to each of the one or more segments of the multimedia content based on the one or more parameters associated with the user profile 106. Finally, the one or more segments of the multimedia content are combined based on the relative segment score assigned to each of the multimedia content to create the highlight of each of the selected one or more recorded multimedia content 302a. Once the highlights have been created, the personalized playlist creation module 215 orders the highlight of each of the selected one or more recorded multimedia content 302a based on information in the user profile 106 for generating the playlist of the one or more highlights. Finally, the generated playlist may be presented to the user as indicated in FIG. 3.

In some embodiments, each entry of highlights in the personalized playlist 302 may be linked with the one or more recorded multimedia content 302a from which the highlight has been created. Hence, when the user selects one of the one or more highlights in the personalized playlist 302, the user may be either directed for a playback of the entire recorded multimedia content 301a associated with the selected highlight or only the selected highlight may be played depending on the nature of request by the user. As an example, when the user selects the multimedia content 302a ‘Sports Center’ from the personalized playlist 302 provided to him, the personalized playlist generator 101 may prompt the user to select to play either the highlight of the ‘Sports Center’ event which has a total playback time 302d of 2 minutes or to play the entire recorded multimedia content 301a corresponding to the ‘Sports Center’ event, which has a total playback time 301d of 30 minutes.

Further, as indicated in the encircled portion of the list 302, it may be noted that the total playback time 302d and the file size 302e of the one or more highlights in the personalized playlist 302 are greatly reduced as compared to the total playback time 301d and the file size 301e of the corresponding recorded multimedia content 301s. Hence, the personalized playlist generator 101 relieves the user from the burden of having to go through the entire list of the plurality of recorded multimedia content 301a and then the need for viewing the plurality of recorded multimedia content 301a for their entire playback time 301d, thereby enhancing the user convenience in managing the plurality of recorded multimedia content 301a.

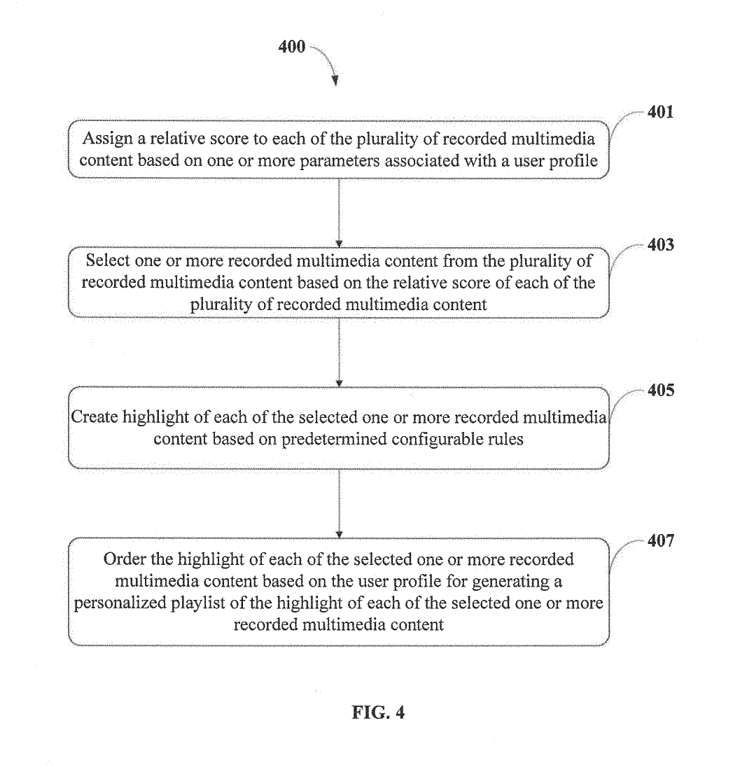

FIG. 4 shows a flowchart illustrating a method for generating personalized playlist of highlights of recorded multimedia content in accordance with some embodiments of the present disclosure.

As illustrated in FIG. 4, the method 400 comprises one or more blocks for generating personalized playlist 109 of highlights of plurality of recorded multimedia content 105 using a personalized playlist generator 101. The method 400 may be described in the general context of computer executable instructions. Generally, computer executable instructions can include routines, programs, objects, components, data structures, procedures, modules, and functions, which perform specific functions or implement abstract data types.

The order in which the method 400 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 401, the personalized playlist generator 101 assigns a relative score to each of the plurality of recorded multimedia content 105 based on one or more parameters associated with a user profile 106. As an example, the one or more parameters associated with the user profile 106 may comprise viewing preference of the user, viewing pattern of the user, content bookmarks created by the user, favorite multimedia genre of the user, last viewed recorded multimedia content by the user, duration of the last viewed recorded multimedia content and information related to one or more electronic devices used by the user for viewing the multimedia content.

At block 403, the personalized playlist generator 101 selects one or more recorded multimedia content 105A from the plurality of recorded multimedia content 105 based on the relative score of each of the plurality of recorded multimedia content 105. In an embodiment, the selected one or more recorded multimedia content 105A having a relative score greater than a predetermined configurable threshold score among the plurality of recorded multimedia content 105 is selected for creating the highlight.

At block 405, the personalized playlist generator 101 creates highlight of each of the selected one or more recorded multimedia content 105A based on predetermined configurable rules 107. As an example, the predetermined configurable rules 107 comprises genre of the selected one or more recorded multimedia content 105A, a standard template for creating the highlight, frequency of access of the genre of the selected one or more recorded multimedia content 105A, pause points in the selected one or more recorded multimedia content 105A, user preference in watching the selected one or more recorded multimedia content 105A of similar genre, bookmarks on the selected one or more recorded multimedia content 105A, presence of content markers in the selected one or more recorded multimedia content 105A and presence of Increased Digital Resolution (IDR) frames within the selected one or more recorded multimedia content 105A. In some implementation, the predetermined configurable rules 107 may be stored in a rules database associated with the personalized playlist generator 101.

In an embodiment, creating the highlight of each of the selected one or more recorded multimedia content 105A further comprises identifying one or more segments of multimedia content in each of the selected one or more recorded multimedia content 105A. Upon identifying the one or more segments, a relative segment score may be assigned to each of the one or more segments of the multimedia content based on the one or more parameters associated with the user profile 106. Then, the one or more segments of the multimedia content may be combined based on the relative segment score to create the highlight of each of the selected one or more recorded multimedia content 105A.

At block 407, the personalized playlist generator 101 orders the highlight of each of the selected one or more recorded multimedia content 105A based on the user profile 106 for generating a personalized playlist 109 of the highlight of each of the selected one or more recorded multimedia content 105A. In some embodiments, the personalized playlist generator 101 further comprises dynamically updating the personalized playlist 109 of the highlights based on the one or more parameters associated with the user profile 106. Also, the personalized playlist 109 may be provided to the user through the one or more electronic devices.

Computer System

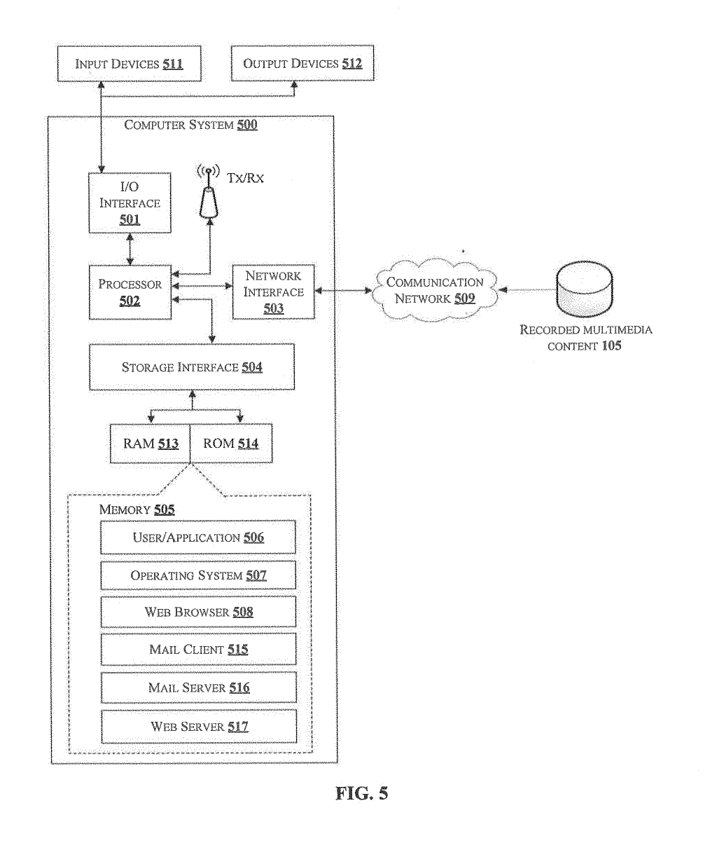

FIG. 5 illustrates a block diagram of an exemplary computer system 500 for implementing embodiments consistent with the present disclosure. In an embodiment, the computer system 500 may be the personalized playlist generator 101 which is used for generating the personalized playlist 109 of highlights of the plurality of recorded multimedia content 105. The computer system 500 may comprise a central processing unit (“CPU” or “processor”) 502. The processor 502 may comprise at least one data processor for executing program components for executing user- or system-generated business processes. A user may include a person, a person using a device such as such as those included in this invention, or such a device itself. The processor 502 may include specialized processing units such as integrated system (bus) controllers, memory management control units, floating point units, graphics processing units, digital signal processing units, etc.

The processor 502 may be disposed in communication with one or more input/output (I/O) devices (511 and 512) via I/O interface 501. The I/O interface 501 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE) or the like), etc.

Using the I/O interface 501, the computer system 500 may communicate with one or more I/O devices (511 and 512). In some embodiments, the processor 502 may be disposed in communication with a communication network 509 via a network interface 503. The network interface 503 may communicate with the communication network 509. The network interface 503 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc.

Using the network interface 503 and the communication network 509, the computer system 500 may access the plurality of recorded multimedia content 105. The communication network 509 can be implemented as one of the different types of networks, such as intranet or Local Area Network (LAN) and such within the organization. The communication network 509 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the communication network 509 may include a variety of network devices, including routers, bridges, servers, computing devices, storage devices, etc.

In some embodiments, the processor 502 may be disposed in communication with a memory 505 (e.g., RAM 513, ROM 514, etc. as shown in FIG. 5) via a storage interface 504. The storage interface 504 may connect to memory 505 including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 505 may store a collection of program or database components, including, without limitation, user/application data 506, an operating system 507, web server 508 etc. In some embodiments, computer system 500 may store user/application data 506, such as the data, variables, records, etc. as described in this invention. Such databases may be implemented as fault-tolerant, relational, scalable, secure databases such as Oracle or Sybase.

The operating system 507 may facilitate resource management and operation of the computer system 500. Examples of operating systems include, without limitation, Apple Macintosh OS X, UNIX, Unix-like system distributions (e.g., Berkeley Software Distribution (BSD), FreeBSD, Net BSD, Open BSD, etc.), Linux distributions (e.g., Red Hat, Ubuntu, K-Ubuntu, etc.), International Business Machines (IBM) OS/2, Microsoft Windows (XP, Vista/7/8, etc.), Apple iOS, Google Android, Blackberry Operating System (OS), or the like. A user interface may facilitate display, execution, interaction, manipulation, or operation of program components through textual or graphical facilities. For example, user interfaces may provide computer interaction interface elements on a display system operatively connected to the computer system 500, such as cursors, icons, check boxes, menus, windows, widgets, etc. Graphical User Interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, JavaScript, AJAX, HTML, Adobe Flash, etc.), or the like.

In some embodiments, the computer system 500 may implement a web browser 508 stored program component. The web browser may be a hypertext viewing application, such as Microsoft Internet Explorer, Google Chrome, Mozilla Firefox, Apple Safari, etc. Secure web browsing may be provided using Secure Hypertext Transport Protocol (HTTPS) secure sockets layer (SSL), Transport Layer Security (TLS), etc. Web browsers may utilize facilities such as AJAX, DHTML, Adobe Flash, JavaScript, Java, Application Programming Interfaces (APIs), etc. In some embodiments, the computer system 500 may implement a mail server stored program component. The mail server may be an Internet mail server such as Microsoft Exchange, or the like. The mail server may utilize facilities such as Active Server Pages (ASP), ActiveX, American National Standards Institute (ANSI) C++/C#, Microsoft .NET, CGI scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the computer system 500 may implement a mail client stored program component. The mail client may be a mail viewing application, such as Apple Mail, Microsoft Entourage, Microsoft Outlook, Mozilla Thunderbird, etc.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

Advantages of the Embodiment of the Present Disclosure are Illustrated Herein.

In an embodiment, the present disclosure provides a method for creating highlights of the plurality of recorded multimedia content.

In an embodiment, the present disclosure provides a method for generating a personalized playlist of the highlight of the plurality of recorded multimedia content based on the interests and viewership profile of the user.

In an embodiment, the method of present disclosure provides a means for selecting appropriate content for a viewer from the plurality of recorded multimedia content using one or more predetermined configurable rules.

In an embodiment, the method of present disclosure helps users in optimal usage of resources, such as Internet and memory resources, since the personalized playlist provided to the user comprises only the highlights of the plurality of recorded multimedia content.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise. A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERALS

| Reference Number | Description |
|---|---|
| 100 | Environment |
| 101 | Personalized playlist generator |
| 103 | Multimedia content recording unit |
| 105 | Plurality of recorded multimedia content |
| 105A | Selected one or more recorded |
| | multimedia content |
| 106 | User profile |
| 107 | Predetermined configurable rules |
| 109 | Personalized playlist |
| 201 | I/O Interface |
| 203 | Processor |
| 205 | Memory |
| 206 | Data |
| 207 | Modules |
| 209 | Other data |
| 211 | Scoring module |
| 213 | Highlight creation module |
| 215 | Personalized playlist creation module |
| 217 | Other modules |

1. A method for generating personalized playlist (109) of highlights of plurality of recorded multimedia content (105), the method comprising:
assigning, by a personalized playlist generator (101), a relative score to each of the plurality of recorded multimedia content (105) based on one or more parameters associated with a user profile (106);
selecting, by the personalized playlist generator (101), one or more recorded multimedia content (105A) from the plurality of recorded multimedia content (105) based on the relative score of each of the plurality of recorded multimedia content (105);
creating, by the personalized playlist generator (101), highlight of each of the selected one or more recorded multimedia content (105A) based on predetermined configurable rules (107); and
ordering, by the personalized playlist generator (101), the highlight of each of the selected one or more recorded multimedia content (105A) based on the user profile (106) for generating a personalized playlist (109) of the highlight of each of the selected one or more recorded multimedia content (105A).

2. The method as claimed in claim 1, wherein the selected one or more recorded multimedia content (105A) having a relative score greater than a predetermined configurable threshold score among the plurality of recorded multimedia content (105) is selected for creating the highlight.

3. The method as claimed in claim 1, wherein creating the highlight of each of the selected one or more recorded multimedia content (105A) further comprises:
identifying one or more segments of multimedia content in each of the selected one or more recorded multimedia content (105A);
assigning a relative segment score to each of the one or more segments of the multimedia content based on the one or more parameters associated with the user profile (106); and
combining the one or more segments of the multimedia content based on the relative segment score to create the highlight of each of the selected one or more recorded multimedia content (105A).

4. The method as claimed in claim 1, wherein the predetermined configurable rules (107) comprises genre of the selected one or more recorded multimedia content (105A), a standard template for creating the highlight, frequency of access of the genre of the selected one or more recorded multimedia content (105A), pause points in the selected one or more recorded multimedia content (105A), user preference in watching the selected one or more recorded multimedia content (105A) of similar genre, bookmarks on the selected one or more recorded multimedia content (105A), presence of content markers in the selected one or more recorded multimedia content (105A) and presence of Increased Digital Resolution (IDR) frames within the selected one or more recorded multimedia content (105A).

5. The method as claimed in claim 1, wherein the predetermined configurable rules (107) are stored in a rules database associated with the personalized playlist generator (101).

6. The method as claimed in claim 1, wherein the one or more parameters associated with the user profile (106) comprises viewing preference of the user, viewing pattern of the user, content bookmarks created by the user, favorite multimedia genre of the user, last viewed recorded multimedia content by the user, duration of the last viewed recorded multimedia content and information related to one or more electronic devices used by the user for viewing the multimedia content.

7. The method as claimed in claim 1 further comprises dynamically updating the personalized playlist (109) of the highlights based on the one or more parameters associated with the user profile (106).

8. The method as claimed in claim 1 further comprises providing the personalized playlist (109) to the user through the one or more electronic devices.

9. A personalized playlist generator (101) for generating personalized playlist (109) of highlights of plurality of recorded multimedia content (105), the personalized playlist generator (101) comprising:
a processor (203); and
a memory (205), communicatively coupled to the processor (203), wherein the memory (205) stores processor-executable instructions, which, on execution, causes the processor (203) to:
assign a relative score to each of the plurality of recorded multimedia content (105) based on one or more parameters associated with a user profile (106);
select one or more recorded multimedia content (105A) from the plurality of recorded multimedia content (105) based on the relative score of each of the plurality of recorded multimedia content (105);
create highlight of each of the selected one or more recorded multimedia content (105A) based on predetermined configurable rules (107); and
order the highlight of each of the selected one or more recorded multimedia content (105A) based on the user profile (106) for generating a personalized playlist (109) of the highlight of each of the selected one or more recorded multimedia content (105A).

10. The personalized playlist generator (101) as claimed in claim 9, wherein the processor (203) selects the one or more recorded multimedia content (105A) having a relative score greater than a predetermined configurable threshold score, among the plurality of recorded multimedia content (105), for creating the highlight.

11. The personalized playlist generator (101) as claimed in claim 9, wherein to create the highlight of each of the selected one or more recorded multimedia content (105A), the instructions causes the processor (203) to:
identify one or more segments of multimedia content in each of the selected one or more recorded multimedia content (105A);
assign a relative segment score to each of the one or more segments of the multimedia content based on the one or more parameters associated with the user profile (106); and
combine the one or more segments of the multimedia content based on the relative segment score to create the highlight of each of the selected one or more recorded multimedia content (105A).

12. The personalized playlist generator (101) as claimed in claim 9, wherein the predetermined configurable rules (107) comprises genre of the selected one or more recorded multimedia content (105A), a standard template for creating the highlight, frequency of access of the genre of the selected one or more recorded multimedia content (105A), pause points in the selected one or more recorded multimedia content (105A), user preference in watching the selected one or more recorded multimedia content (105A) of similar genre, bookmarks on the selected one or more recorded multimedia content (105A), presence of content markers in the selected one or more recorded multimedia content (105A) and presence of Increased Digital Resolution (IDR) frames within the selected one or more recorded multimedia content (105A).

13. The personalized playlist generator (101) as claimed in claim 9, wherein the processor (203) stores the predetermined configurable rules (107) in a rules database associated with the personalized playlist generator (101).

14. The personalized playlist generator (101) as claimed in claim 9, wherein the one or more parameters associated with the user profile (106) comprises viewing preference of the user, viewing pattern of the user, content bookmarks created by the user, favorite multimedia genre of the user, last viewed recorded multimedia content by the user, duration of the last viewed recorded multimedia content and information related to one or more electronic devices used by the user for viewing the multimedia content.

15. The personalized playlist generator (101) as claimed in claim 9, wherein the processor (203) dynamically updates the personalized playlist (109) of the highlights based on the one or more parameters associated with the user profile (106).

16. The personalized playlist generator (101) as claimed in claim 9 wherein the processor (203) provides the personalized playlist (109) to the user through the one or more electronic devices.
